(19) United States
(12) Patent Application Publication
(10) Pub. No.: US 2016/0324715 A1
(43) Pub. Date: Nov. 10, 2016

(54) Ergonomic Auxiliary Crutch Pad

(71) Applicant: Curtis J. Huggins, Evergreen, CO (US)

(72) Inventor: Curtis J. Huggins, Evergreen, CO (US)

(21) Appl. No.: 14/668,894

(22) Filed: Mar. 25, 2015

(51) Int. Cl. A61H 3/02

(52) U.S. Cl. CPC A61H 3/02; A61H 2201/16; A61H 2201/0192; A61H 2201/1645

(57) ABSTRACT

The invention is an ergonomic auxiliary crutch pad with guide extensions that replaces the underarm supports on conventional “Y” shaped crutches. The upper armpit pad is replaced by two curved adjustable extensions that fit over the upper end tubes of the conventional crutch and are connected via a flexible strap covered by a replaceable soft pad between the two upper “Y” tubes. The ergonomically designed auxiliary pad and guide extensions positions, aligns and stabilizes the crutch while eliminating chaff, soreness and potential nerve damage caused by current armpit weight-bearing supports on conventional “Y” crutch designs.

This substitute specification makes no changes in the text and neither adds nor deletes any matter.

There are no cross referenced related applications.

This invention was not conceived while being Federally sponsored.

There are no parties to a joint research agreement.

No sequence listing is being submitted.

### BACKGROUND OF THE INVENTION

Almost everyone has at sometime in their lives been required to use a crutch in order to remain mobile. The biggest complaint among crutch users is that crutches are not comfortable. The crutch rubs and chaffs the under arm area and has been medically documented to cause palsy in the arms due to compression of the Axillary nerve.

### BRIEF SUMMARY OF THE INVENTION

The invention is an ergonomically designed auxiliary crutch support pad with guide extensions that align and stabilize the conventional “Y” crutch while eliminating most chaff, soreness and potential nerve damage of the Axillary nerve caused by current armpit weight-bearing supports on conventional “Y” crutch designs.

### DESCRIPTION OF THE VIEWS OF THE DRAWINGS

Page 1/3 contains two drawings, FIG. 1 and FIG. 2.

FIG. 1 is a drawing of a common “Y” tube crutch with the invention (1) attached.

FIG. 2 is a drawing of a common “Y” tube crutch with the invention (1) detached.

Page 2/3 contains one view, FIG. 3

FIG. 3 is a drawing of the invention (1) assembled as it would appear on the common “Y” crutch with the three main components identified as (3) guide extensions, (4) comfort cushion, (5) flexible support strap.

Page 3/3 contains one view, FIG. 4

FIG. 4 is a drawing of the invention (1) as an exploded view identifying the various details of each component.

### DETAILED DESCRIPTION OF THE INVENTION

The invention is an ergonomically designed auxiliary crutch support pad with guide extensions that align and stabilize the conventional “Y” crutch while eliminating chaff, soreness and potential Axillary nerve damage caused by current armpit weight-bearing supports on conventional “Y” crutch designs.

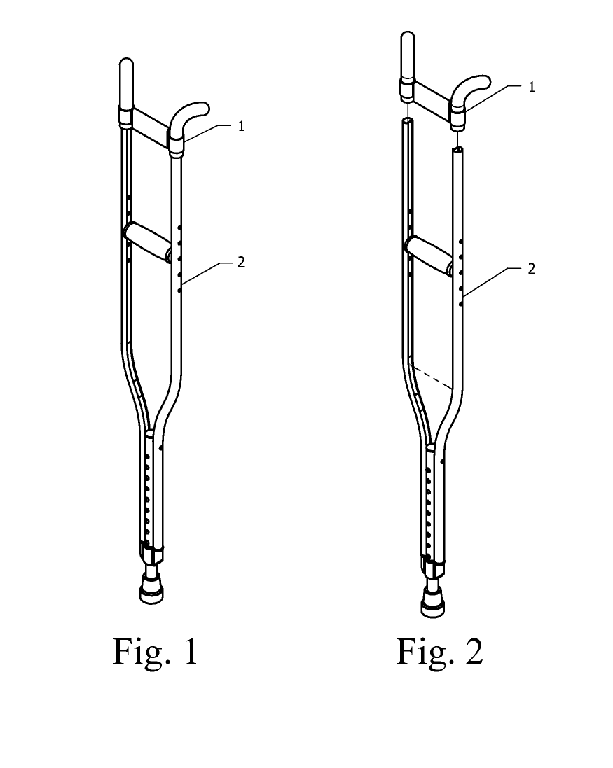

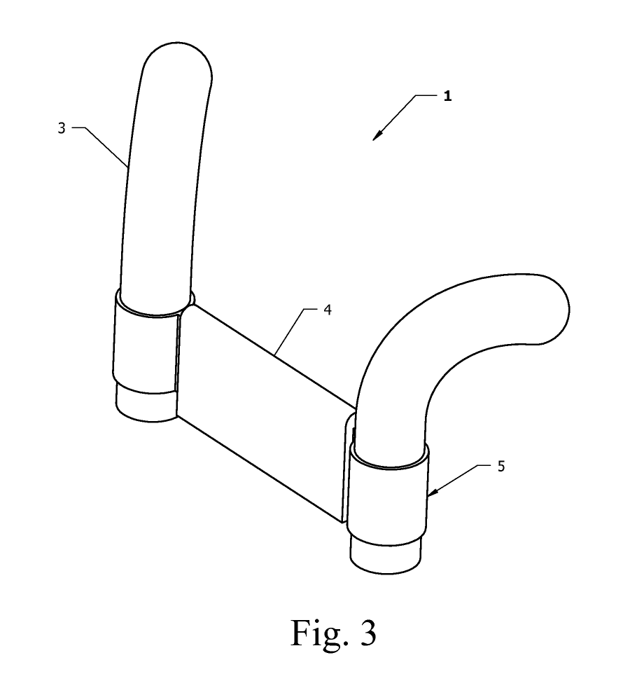

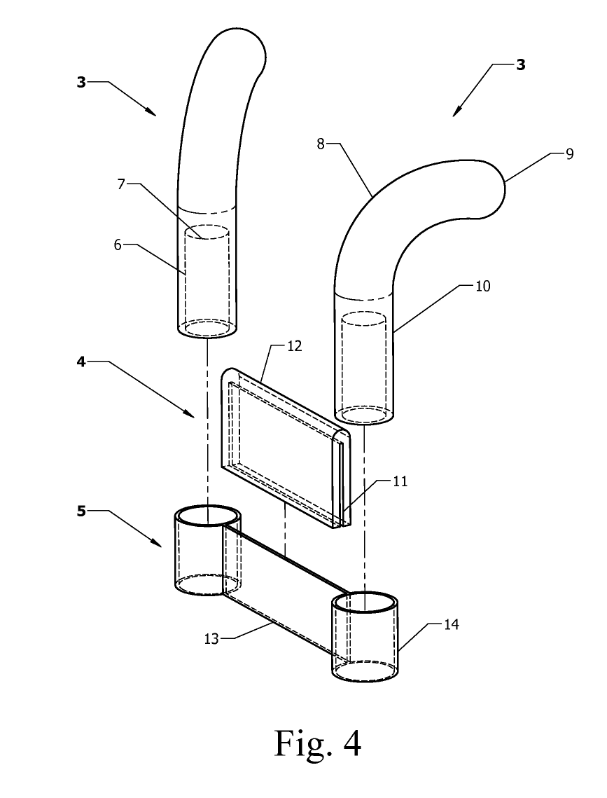

The invention has three components FIG. 3 labeled (3) (4) & (5)) that are related as follows; the flexible support strap, FIG. 3 item (5), fits over each of the lower ends of the guide extensions. FIG. 3 item (3) in turn fits over the upper ends of FIG. 2 items (2), and spans the distance between the conventional “Y” crutch tubes, FIG. 1 & FIG. 2 item (2). The flexible support strap, FIG. 3 item (5), allows the crutch to fit comfortably under the arm of the user. Added comfort is provided by a cushion FIG. 3 item (4). Specifically, the support strap FIG. 3 item (5) is constructed of a flexible band FIG. 4 item (13) to two integrated flexible loops FIG. 4) item (14) over each lower end of two injection molded plastic guide extensions FIG. 4 item (10). The guides extensions FIG. 3 item (3) are injection molded, solid plastic, with radiuses FIG. 4 item (8) and rounded ends FIG. 4 items (9). The guide extensions have a lower straight section FIG. 4 item (10) having each end counter-bored FIG. 4 items (6) (7) that fit over and are able to rotate on the upper ends of the conventional “Y” crutch FIG. 2 item (2). The guide extensions FIG. 3 Item (3) and FIG. 4 item (6) & (7) position, stabilize and align the crutch to the user. Rotating the extension guides FIG. 4 item (3) around the upper tubes FIG. 2 item (2) of the conventional “Y” crutch increases gender specific comfort and fit at an angle where the supports are pointing outward from the user's side and slightly away from each other. This feature helps confine the users arm so that the crutch can't slip from underneath the user, thus increasing stability, comfort and fit. The comfort cushion FIG. 3 item (4) and FIG. 4 items (12) is constructed from a low density, closed cell, non-absorbing and non-allergenic foam that sandwiches FIG. 4 item (11) the flexible support strap FIG. 4 item (5). The comfort cushion acts to soften the edges of the support strap while allowing the support pad to mold to the users unique shoulder shape without chaff. The user's weight is distributed between the invention and the lower hand holds which improves the balance by distributing the users weight on the hand supports which lowers the pivot point of the center of gravity and lessens the compression of the Axillary nerve.

The user adjusts the crutch height as instructed by the crutch manufacturer and positions the crutch slightly below the armpit at a comfortable height. The invention aligns the crutch under the armpit via the guide extensions and the flexible support strap and as the user moves forward their weight is supported by the arms and minimally by the invention which acts to align position and balance the movement. The invention would be implemented as a replacement on existing “Y” crutches or as original equipment on new crutches.

1. The Ergonomic Auxiliary Crutch Pad uses a flexible support strap and rotating extension guides to align, position and stabilize conventional “Y” crutch designs.

2. The Ergonomic Auxiliary Crutch Pad uses a comfort cushion made of closed cell, low density, non absorbing, non allergenic foam that eliminates underarm chaff and potential soreness.

3. The Ergonomic Auxiliary Crutch Pad increases gender specific comfort and fit by rotating the extension guides outward from the user's side while confining the users arm so that the crutch can't slip.

4. The Ergonomic Auxiliary Crutch Pad lessens the potential of Axillary nerve damage caused by current armpit weight-bearing supports on current “Y” crutch designs.
